(19) United States
(12) Patent Application Publication
(10) Pub. No.: US 2005/0127695 A1
(43) Pub. Date: Jun. 16, 2005

(54) Remote controlled load lifting hook and methods

(75) Inventors: Albert E. Cranston, Oregon City, OR (US); Steven C. Hooper, Puyallup, WA (US)

Correspondence Address: KLARQUIST SPARKMAN, LLP, 121 SW SALMON STREET, SUITE 1600, PORTLAND, OR, 97204, US

(73) Assignee: Cranston Diversified Industries, Inc.

(21) Appl. No.: 11/005,855

(22) Filed: Dec. 6, 2004

Related U.S. Application Data
(60) Provisional application No. 60/528,759, filed on Dec. 10, 2003.

(51) Int. Cl. B66C 1/34

(52) U.S. Cl. 294/82.3

(57) ABSTRACT

One embodiment of a hook system for lifting heavy loads includes a body, a hook coupled to the body and a lock member positioned at least partially within the body and engageable with the hook, where the locking axis of the lock pin is not coaxial with the body axis of the body. Another embodiment has a hook clearing member coupled to the body that can clear lifting slings from the hook as it moves from a closed position to an open position. In another embodiment, the body is rotatably coupled to a swivel and has a rotation pin allowing for selective rotation of the body relative to the swivel. Another embodiment has a deliberate engagement feature providing a predetermined resistance to movement of the hook from an open position to the closed position to prevent inadvertent locking. Another embodiment has a retractor that moves the hook, when unlocked, toward an open position.

### CROSS REFERENCE TO RELATED APPLICATION

The present application claims the benefit of U.S. Provisional Application No. 60/528,759, filed on Dec. 10, 2003. The prior application is incorporated herein by this reference.

### FIELD

This application relates to hooks used in lifting loads, and in particular, to remote controlled hooks used in lifting and maneuvering heavy loads.

### BACKGROUND

Hooks used in lifting applications for general construction, fishing, logging, cargo handling, foundry work and other industries, are known. In some situations, there are advantages to providing a hook that can be controlled remotely, e.g., so as not to require an operator to directly handle the hook during one or more of the steps associated with a lifting operation. Examples of remote controlled hooks are described in commonly owned U.S. Pat. No. 4,095,833, U.S. Pat. No. 4,193,627, and U.S. Pat. No. 4,530,535, which are incorporated herein by this reference.

One common lifting application is cargo handling, which includes the lifting of cargo into and out of ships using a crane. Typically, hooks for lifting cargo are attached to strapping, webbing, wire and/or other type of slinging arrangement arranged around the cargo. The hooks may be used in groups that are suspended from a lifting frame and/or crane, usually by lifting chains. The hooks are engaged with the slings, usually by hand. Typically, the hooks are locked in a closed position, and the operator then engages the sling by passing it through to the throat of the hook, which may involve depressing a spring-loaded latch extending over the hook gap. It is also possible to lock the hook in place after the slings are received in the hook throat.

After the cargo is lifted and transported, it is desirable to release or unlock the hook remotely, preferably without requiring personnel to be in the direct area of the hooks to manually release them. Conventional cargo hooks are pneumatically controllable to be released or “unlocked” from the closed position to an open position in which the hook can freely pivot, and will usually be released from the sling without handling by an operator when the cable to which the hook is attached is raised. In some situations, conventional cargo hooks are configured to be unlocked for a predetermined time, and may automatically relock after that time. If the hooks relock while some or all of the slings are still in place within the throat of the hook, a second unlock cycle is necessary. If the crane operator remains unaware that the hooks have relocked and at least one of the slings is still attached, the current cargo may be jerked or moved unexpectedly when the operator attempts to move the hooks believed to be no longer underload.

Additional problems can arise if the lifting chain has too much or too little rotational freedom relative to the hook. If the hook is configured with a pneumatic line or other sources of power for the lock mechanism, care must be taken to protect the connections and ensure that the line is not entangled with the chain during operation. Also, hooks must be durable to withstand the rigors of the harsh handling environment, yet easy to service as necessary to avoid extensive downtime, e.g., during expensive procedures, such as a critical foundry operation or during unloading at a busy dock.

### SUMMARY

To address these and other problems in conventional hooks, some embodiments of the new lifting hook design allow the degree to which the hook may rotate relative to the chain to be selected as desired. The hook may be configured to provide for free rotation of the hook relative to the chain, e.g., as provided by a swiveling section of the hook assembly, or the relative rotation may be confined to a predetermined range, e.g., up to 180 degrees as one example. As another alternative, the hook may be rotationally fixed relative to the chain as desired, e.g., by securing the swiveling section relative to the hook.

Embodiments of the new lifting hook design can include a locking mechanism that operates along an axis distinct from a main or lifting axis of the assembly. By disassociating the locking axis from the main axis (usually the axis of the body of the lifting hook), the locking components may be accessed more readily. In some conventional hooks, the locking axis is usually coaxial with the body axis, but this design can complicate disassembly of the device and lengthen the time required for service. In embodiments of the new lifting hook, the distinct locking axis may be parallel to but offset from the body axis (i.e., to the right, left, front or rear), or the distinct locking axis can be angled relative to the body axis. In specific implementations, the locking device may be angled at about 45 or about 90 degrees relative to the body axis, although any other angle that sufficiently spaces the locking components from the body axis can be used, including an angle from about 15 degrees to about 90 degrees.

Embodiments of the new lifting hook design can include a hook clearing member that functions to push off the sling or other object within the hook as the hook is pivoted to an open position, thus assisting in ensuring that the hooks do not remain connected to slings unintentionally while the hooks are subject to being relocked.

Embodiments of the new lifting hook design can include a deliberate locking feature requiring a positive manual effort, e.g., against a predetermined resistance, to close the hook before it can be relocked in an effort to reduce instances of unintentional relocking.

Embodiments of the new lifting hook design can include a retractor that functions to urge the hook toward an open position when the hook is free to pivot.

The disclosed apparatus and methods should not be construed as limiting in any way. Instead, the present disclosure is directed toward novel and nonobvious features and aspects of the various disclosed embodiments, alone and in various combinations and subcombinations with one another. The methods and apparatus are not limited to any specific aspect or feature or combinations thereof, nor do the disclosed methods and apparatus require that any one or more specific advantages be present or problems be solved.

### BRIEF DESCRIPTION OF DRAWINGS

FIG. 1 is a sectioned elevation view of an embodiment of the remote controlled lifting hook in an unlocked condition with the hook pivoted, showing a body of the lifting hook, a locking device positioned approximately perpendicular to an axis of the body, a swivel cap coupled to the body, and an attached lifting chain.

FIG. 2 is an exploded perspective view of the lifting hook of FIG. 1.

FIG. 3 is an elevation view of another embodiment of a remote controlled lifting hook similar to FIG. 1, except the remote controlled locking device operates on an axis positioned at an acute angle relative to the body axis and the hook is shown in a locked position.

FIG. 4 is a perspective view of the swivel cap showing an end with a slot and a pin aperture, each of which is sized to receive a pin for selectively controlling the rotational range of the swivel cap relative to the body.

FIG. 5 is a perspective view of the lifting hook shown in FIG. 3, except with the hook clearing member removed to show the hook retracting spring.

FIG. 6 is a sectioned elevation view of another embodiment of a remote controlled lifting hook similar to FIG. 1, except the remote controlled locking device operates on an axis generally coaxial with the body axis.

FIG. 7 is a plan view of the lifting hook of FIG. 6 taken at the line 7-7 in FIG. 6.

FIG. 8 is a sectioned elevation view showing part of another embodiment of a remote controlled lifting hook similar to FIG. 6, except incorporating a hook clearing member and a different hook return spring.

FIG. 9 is a sectioned elevation view similar to FIG. 8, except showing the hook in an unlocked and open position.

FIG. 10 is a partial perspective view showing a lower front side of the lifting hook of FIG. 8, except fitted with an alternative latch having a free end that is received in a recess of the hook tip.

FIG. 11 is a partial perspective view showing a lower rear side of the lifting hook of FIG. 8, except the hook is fitted with a different latch.

### DETAILED DESCRIPTION

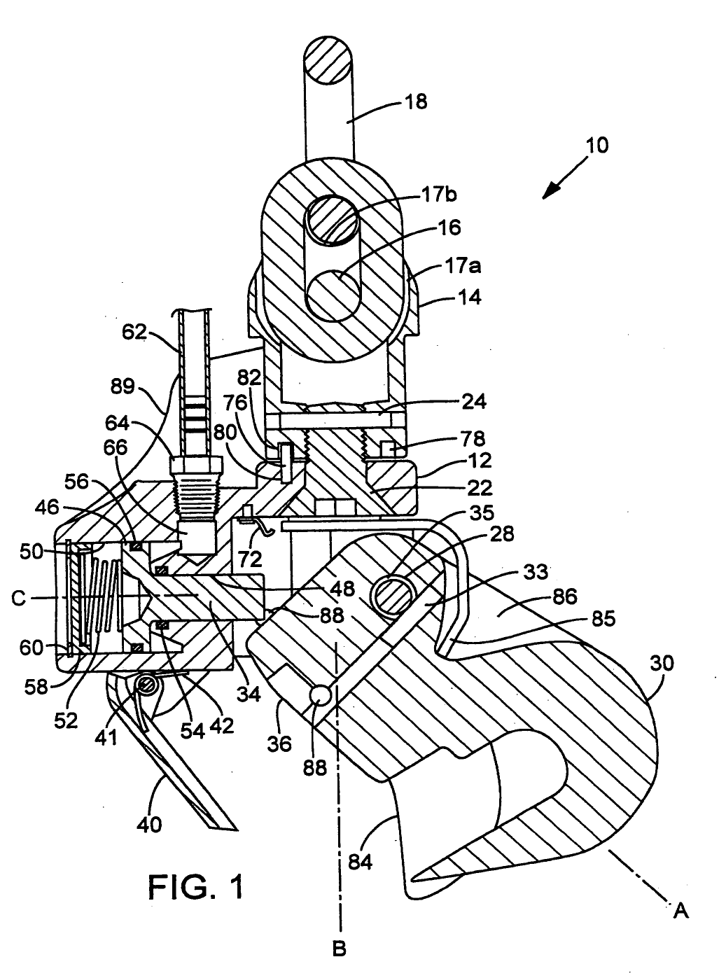

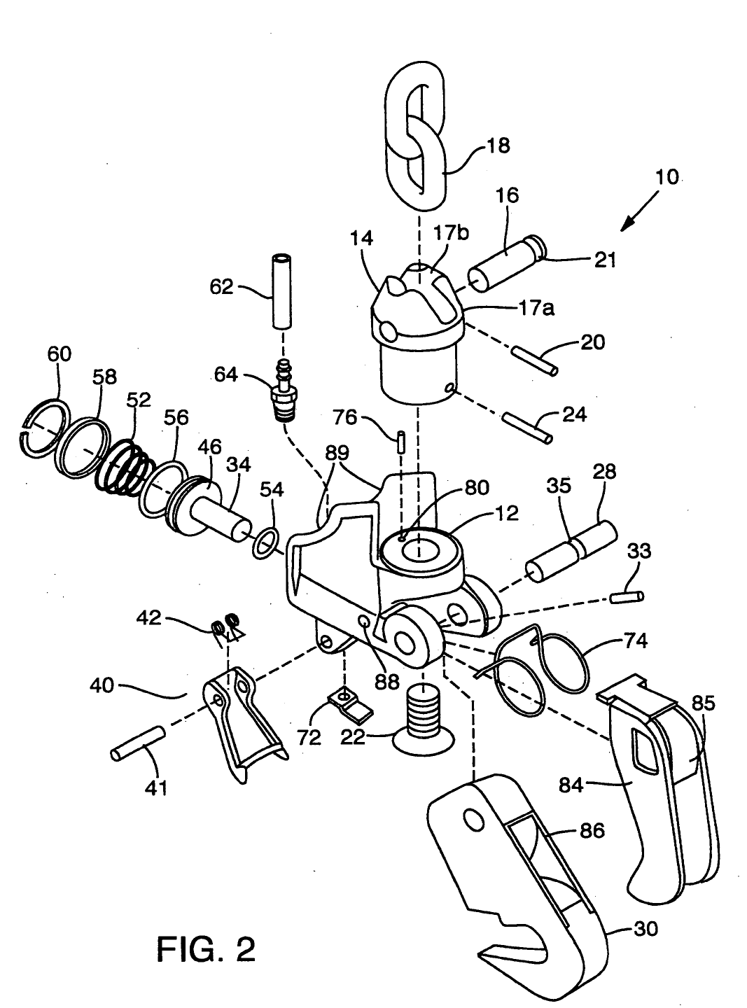

Referring to FIGS. 1 and 2, a first embodiment of a lifting hook 10 includes an elongate body 12 and a swivel cap 14 coupled to the body for selective rotation relative to the body, as is described in detail below. The swivel cap 14 is fitted with a transverse chain retaining pin 16 for coupling a lifting chain 18 (shown partially in the figures) to the lifting hook. Referring to FIG. 2, there is a transverse retaining pin 20 that interfaces with a groove 21 on the pin 16 to retain it in place within the swivel cap 14. The swivel cap 14 can have internal link receiving portions, such as a first link receiving portion 17a and a second link receiving portion 17b, which are shaped to define cavities that receive and support the first and second links, respectively, of the chain 18.

The swivel cap 14 is coupled to the body 12 by an attachment member 22 extending upwardly through the body 12 and into the swivel cap 14. The attachment member 22 may form a threaded connection or another type of connection. In the illustrated embodiment, the attachment member 22 is a socket head cap screw that also has a groove for receiving a transverse retaining pin 24 extending through the swivel cap 14.

A hook 30 is pivotably coupled to the body 12 by a pivot pin 28. The pivot pin 28 may be secured in position by a retaining pin 33 that engages a groove 35 on the pivot pin 28.

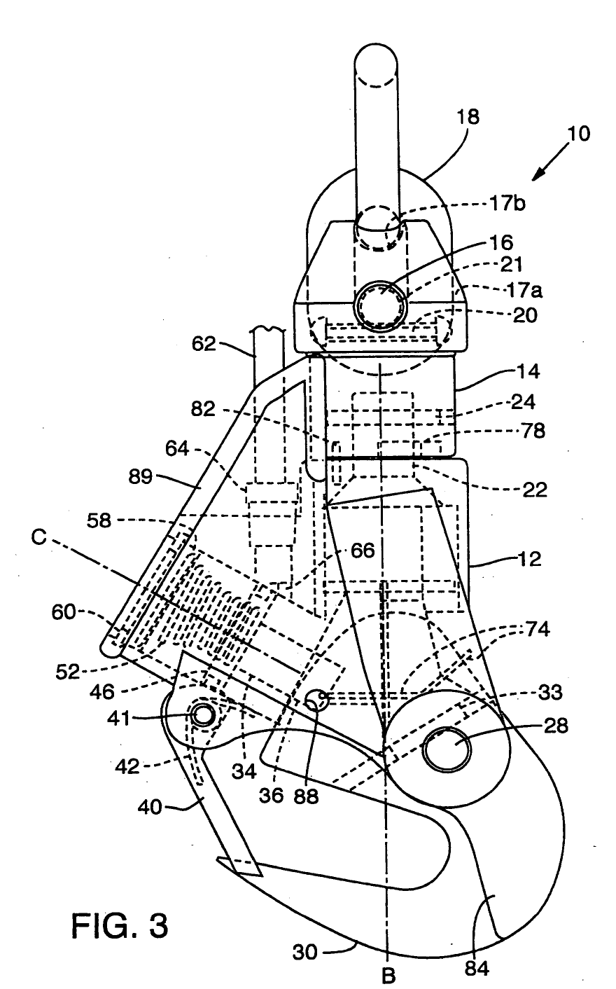

In FIG. 1, the hook 30 is shown in a pivoted position in which a hook axis A defined by the hook 30 intersects a body axis B defined by the body. The hook axis A and the body axis B are generally defined at an approximately central location of the hook and the body, respectively. When the hook is rotated from the pivoted or open position shown in FIG. 1 to the closed position (see, e.g., FIG. 3), the hook axis A and the body axis B are generally parallel, and in the illustrated embodiment, are generally coaxial.

The hook 30 can be selectively secured or locked in the closed position with a lock mechanism. In the illustrated embodiments, a lock member, such as a lock pin 34, is selectively controlled to extend and engage a recess 36 formed in the hook 30, thereby preventing the hook from pivoting about the pivot pin 28. In the embodiment of FIGS. 1 and 2, a locking axis C is approximately perpendicular to the body axis B, and is also approximately perpendicular to the hook axis A when the hook 30 is in the closed position. In other embodiments, as described below, the locking axis C is configured differently.

The lock pin 34 may be a rod of a piston (as shown in the illustrated embodiments), the plunger of a solenoid, or other type of controllably movable pawl or member. The lock pin 34 or locking member may be a single component that is directly coupled to the hook, or it may be a multiple component assembly in which the controllably movable member moves another member that contacts and secures the hook.

As shown in FIG. 1, the lock pin 34 in the illustrated embodiments is slidably received in a bore 48 of the body 12. The lock pin 34 has an attached piston 46 that is slidably received in a bore 50. A spring or other biasing device 52 is positioned to urge the lock pin 34 towards its locked position. In FIG. 2, the spring 52 bears against the piston 46.

The lock pin 34/piston 46 and spring 52 are secured in place by a cap 58 and a snap ring 60. The lock pin 34 and the piston 46 may be fitted with respective seals 54 and 56 as shown. The removable snap ring 60 and cap 58 allow easy access for servicing and/or changing the seals 54, 56 and the lock pin 34. There may be inspection openings 88 formed in the hook 30 and the body 12, which, when aligned as shown, e.g., in FIG. 3, permit an operator to visually confirm that the lock pin 34 is fully extended and in the locked position.

A latch 40 for the hook 30 is coupled to the body 12. In the illustrated embodiments, the latch 40 is pivotably coupled to the body 12 by a pivot pin 41 and is biased to the closed position as shown in FIG. 2, e.g., by a spring 42. When the hook 30 is in the locked position, the latch 40 functions to prevent inadvertent release of a sling or slings within the throat of the hook.

As described, the hook 30 can be remotely controlled. For example, the hook 30 may be selectively controlled to withdraw the lock pin 34 from the recess 36, thereby allowing the hook 30 to pivot from the lock position to the pivoted position, e.g., to release the load. In the illustrated embodiments, the hook 30 is pneumatically controlled using compressed air or other compressed gas, such as nitrogen. In other implementations, a hydraulic system could be used. It would also be possible to use an electrically actuated solenoid, servo motor or other similar device.

In the embodiment shown in FIGS. 1 and 2, there is a pneumatic line 62 for providing a supply of pressurized gas which is connected to a fitting 64 attached to the body 12. A passageway 66 leads from the fitting 64 to one side of the piston 46. When desired, pressure can be supplied to this side of the piston 46 to move it against the force of the spring 52 and cause the lock pin to be withdrawn.

The body 12 can be structured to provide protection for the fluid or power connection. For example, as shown in FIG. 1, the body can have flanges 89 that extend above and to the side of the fitting 64 to provide protection for the connection between the pneumatic line 62 and the fitting 64 during use and handling.

### Hook Clearing

In some embodiments, the lifting hook 10 may be fitted with a hook clearing member 84 that assists in ensuring that any sling within the hook is completely removed from the hook when the hook is pivoted from the lock position to the open position. In FIG. 1, the hook clearing member 84 is shown attached to the body 12 and having two opposing sides that straddle the hook 30. When the hook 30 is fully pivoted to the open position as shown in FIG. 2, the throat of the hook, i.e., the portion of the hook that bears the load, moves leftward beyond the stationary sides of the hook clearing member 84.

Although shown as a separate piece in the illustrated embodiments, it would of course be possible for the hook clearing member 84 to be formed as one piece with the body. Alternatively, other hook clearing structures that incorporate a moving element to more positively assist in disengaging the sling from the hook could be used.

The hook clearing member 84 can also have a stop 85 positioned to contact the hook 30 and serve to prevent rotation of the hook beyond a predetermined “fully open” position. In FIG. 1, the stop 85 is shown extending within a recess 86 and bearing against an inner surface of the hook 30 to prevent further rotation.

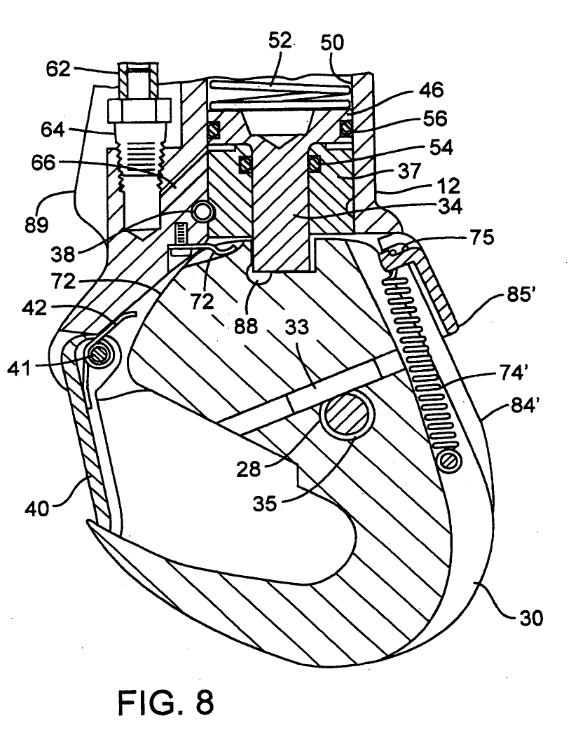

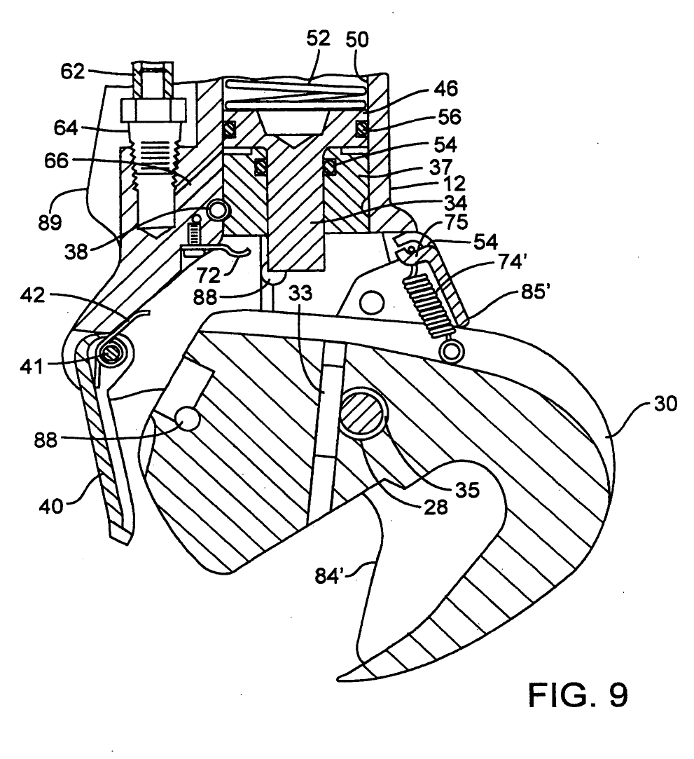

FIGS. 8-11 show a hook clearing member 84′, which is another variation. As best seen in FIG. 9, the hook clearing member 84′ in this example does not project beyond the tip of the hook 30 when the hook is pivoted to the fully open position, but the hook throat does pivot beyond the member 84′. As also best shown in FIG. 9, there is a stop 85′, which is an edge of the rear connecting portion of the hook clearing member 84′. The rear surface of the hook 30 bears against the stop 84′ when the hook is in the fully open position.

### Hook Retracting

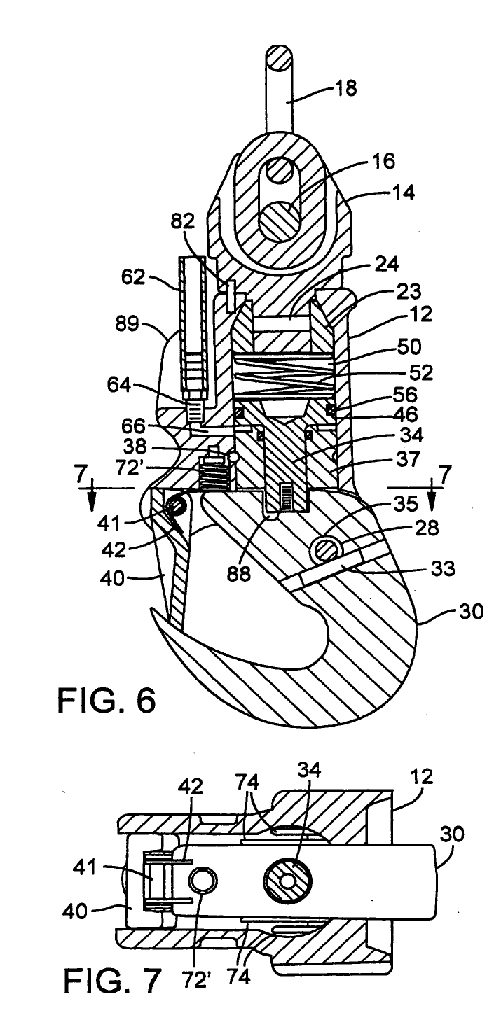

The hook may be fitted with a retracting member that urges the hook 30 toward the open position when the hook is free to pivot, e.g., when the lock pin 34 has been withdrawn. As best shown in FIG. 2, the retractor can be a spring 74 with two generally symmetrical side portions and a connecting middle portion between the side portions. As assembled in FIG. 3, each side portion of the spring 74 has an end fixed to the body and extending laterally along an inner surface of the body and around the openings for the pivot pin 28, angling upward and across a back side of the hook 30 to join the other side portion. The ends of the spring 74 can be bent to engage the inspection holes 88 in the body as shown. FIG. 5 is another view of a lifting hook without the hook clearing member 84 that shows the spring 74. FIG. 7 shows a different view of the spring 74 in relation to the body 12 and the hook 30.

FIGS. 8, 9 and 11 show a different hook retracting configuration. In FIGS. 8, 9 and 11, there is a coil spring 74′ with a first moving end attached to the hook 30 and a second stationary end attached to a stationary portion of the lifting hook. In the specific example of FIGS. 8, 9 and 11, the spring is attached to a bent tab 75 of the hook clearing member 84′.

### Deliberate Engagement Prior to Locking

The lifting hook may have a deliberate engagement feature to prevent inadvertent locking of the hook 30 by the lock pin 34. Depending upon the position of the lifting hook at rest, e.g., if it was lying with its rear surface in contact with the floor or the top surface of the cargo, the hook 30 could be in a closed position and subject to being unintentionally relocked. Unintentional relocking could occur if the controlled unlock time for the lock pin expires, i.e., the piston 46 is allowed to close, while the hook is in the closed position. Unintentional relocking may be undesirable if there are still slings within the hook 30. A deliberate engagement feature such as a spring 72 can be positioned on the body 12 to bias the hook 30 slightly away from the closed position. Thus, the spring 72 requires the operator to manually apply a predetermined positive force to pivot the hook 30 to the fully closed position, and thus helps to ensure that the hook 30 is only fully closed when it is intended to be relocked.

The spring 72 may be a flat leaf spring held in place on the body 12 with a set screw as shown in FIG. 1 (see also FIGS. 2, 8 and 9). Alternatively, there may a coil spring 72′ as shown in FIGS. 6 and 7. Although not specifically shown in the drawings, a member made from a resilient material, such as rubber or the like, could be configured to serve as the deliberate engagement feature. Other biasing arrangements would also be suitable, as would be known to one or ordinary skill in the art.

With the spring 72 or 72′, an attempt to relock the hook 30 will not be successful unless the biasing force of the spring is overcome, which would ordinarily require an operator's manual manipulation of the hook 30.

### Selective Rotation

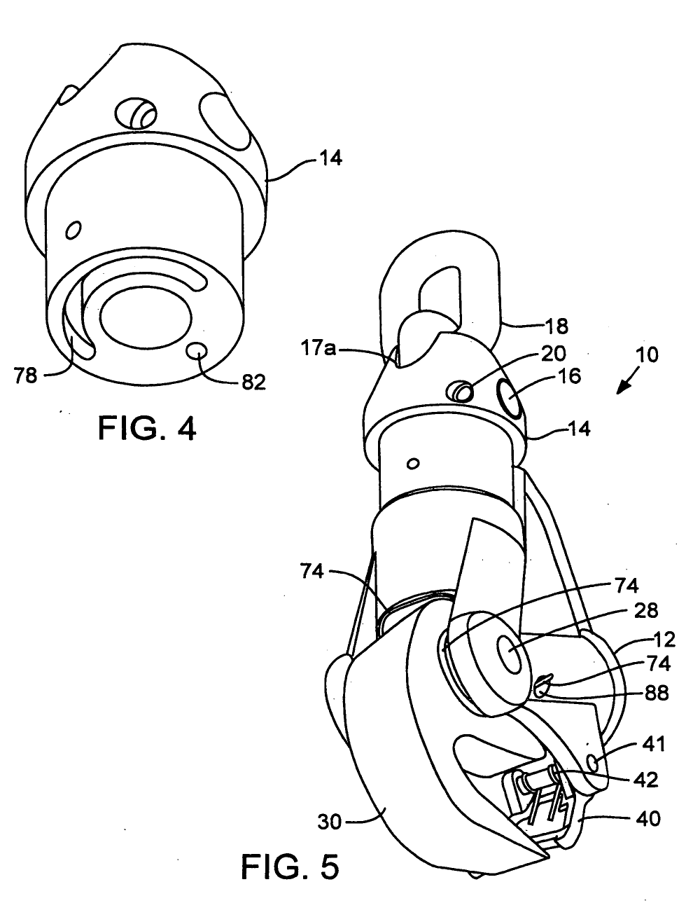

As indicated, the swivel cap 14 can be configured (1) to rotate freely, i.e., over at least 360 degrees relative to the body 12, (2) to rotate over a desired angular range (e.g., over about 180 degrees) relative to the body 12, or (3) to be fixed and not rotate relative to the body 12. If free rotation is desired, the body 12 and the swivel cap 14 are assembled together without the pin 76. If rotation over an angular range is desired, the pin 76 is inserted into the body pin aperture 80, and the swivel cap 14 is assembled together with the body 12 such that the pin 76 is in a slot 78 of the desired angular range. FIG. 4 is a perspective view of the swivel cap 14 showing an end with the slot 78. The pin 76 can be positioned in the slot 78 when the swivel cap 14 and the body 12 are assembled together to restrict rotation of the swivel cap 14 to the angular range of the slot 78, i.e., about 180 degrees in this example. If no relative rotation is desired, the pin 76 is inserted into the body pin aperture 80, and the other end of the pin is inserted into the cap pin aperture 82 when the swivel cap 14 is assembled together with the body 12.

The selective rotation functionality can be made available for use while the lifting hook is assembled. For example, a longer pin 76 can be used in conjunction with a cap pin aperture 80 that extends through the swivel cap 14 cap to provide the user with the ability to select the desired relative rotation. If limited rotation is desired, the protruding pin is depressed to engage the body pin aperture 82 (no rotation) or the slot 78 (rotation only a limited angular range) in the body 12. The pin can be secured against unintentional movement, e.g., by use of a detent or similar retainer.

### Coaxial Locking Axis

FIGS. 6 and 7 show another embodiment of the lifting hook. This embodiment is similar to the other embodiments described above, except (1) the locking axis C is approximately coaxial with the body axis B, and (2) the swivel cap 14 is coupled to the body 12 by a collar 23 instead of the bolt 22. As described above, the deliberate engagement feature is the coil spring 72′ instead of the flat leaf spring 72.

FIGS. 8-11 show another embodiment with a vertical locking axis. In the embodiments with a vertical locking axis, as best shown in FIGS. 6, 8 and 9, the lifting hook can include a removable cartridge 37 in which is formed the cylinder 48 for the lock pin 34. The cartridge 37 can be secured with a retaining pin 38 that extends into the body. The removable cartridge construction may be advantageous in some embodiments to allow installation and removal of the lock pin 34/piston 46.

### Locking Axis Variations

As indicated above, the lifting hook can be configured such that the locking axis is not coaxial with the axis of the body. In some embodiments, the locking axis and the axis of the body intersect to form an acute angle. In still other embodiments, as in the embodiment of FIGS. 1 and 2 and the embodiment of FIGS. 3 and 5 the locking axis and the axis of the body intersect to form a 90 degree angle and a 45 degree angle, respectively. Implementing a locking axis that is not coaxial with the axis of the body provides certain advantages with respect to ease of disassembly of the lock pin 34 and related components. For example, it may be possible to leave the lifting hook connected to the lifting chain 18 while servicing one of the seals. Although not shown, the locking axis can be offset from but still parallel to the body axis to achieve some of the same advantages.

For other implementations, such as is shown in the embodiment of FIGS. 6 and 7, the lifting hook may have a locking axis generally coaxial with the body axis and still realize other advantages as described.

### Latch Variations

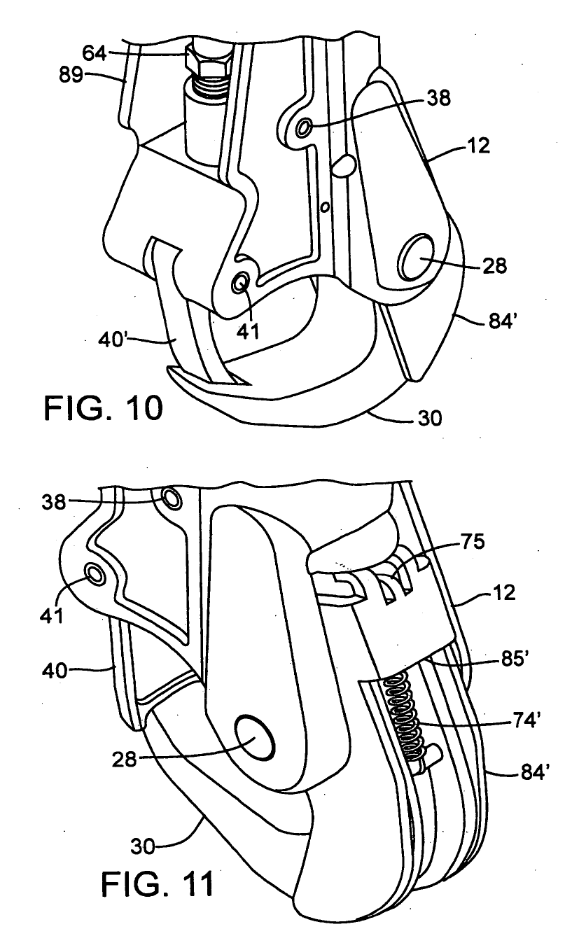

As best shown in FIGS. 2 and 11, the latch 40 may be sized slightly wider than the tip of the hook 30 such that the latch 40 protrudes beyond the sides of the hook. For some applications, it may be desirable to incorporate a latch 40′ that is generally narrower than the hook 30. As best shown in FIG. 10, the latch 40′ is pivotably connected to the body 12 and spring biased similar to the latch 40, but the hook 30 is shaped with a recess to receive the free end of the latch 40′ and allow it to pivot.

### General Construction

In general, it is desirable to construct the lifting hook such that the outermost surfaces tend to slide away from objects with which they make inadvertent contact during use, instead of catching on or snagging such objects. In use, the lifting hooks are generally suspended in a generally upright position, i.e., with the body axis B generally vertical. Therefore, viewing the lifting hook in elevation, the outermost surfaces that might come into inadvertent contact with, e.g., the side of a cargo ship, are generally gently sloping or curved, and the use of planar surfaces or projections (e.g., the heads of fasteners), which might be prone to interfere with and “grab” objects, is minimized. Thus, the overall construction of the lifting hooks in the described embodiments is referred to as “non-snagging.”

The various components of the lifting hook 10 may be made of any suitable material. In most implementations, the major components are made of a steel. Other materials, such as fiberglass, plastics, composites, ceramics, etc., are also suitable, depending upon the particular environmental conditions and operating requirements. In some implementations, certain components are made of a material resistant to environmental effects, e.g., stainless steel or variations of bronze may be used for one or more components where corrosion is a concern.

Although the invention has been disclosed in this patent application by reference to the details of some preferred embodiments, it is to be understood that this disclosure is intended in an illustrative rather than in a limiting sense, as it is contemplated that modifications will readily occur to those skilled in the art within the spirit of the invention.

1. A load lifting hook system having a remote control, comprising:
an elongated body defining a body axis;
a hook movably coupled to the body; and
a lock member positioned at least partially within the body and selectively engageable with the hook via the remote control to lock the hook in a closed position;
wherein a locking axis of the lock member is not coaxial with the body axis.

2. The hook system according to claim 1, wherein the locking axis of the lock member is substantially perpendicular to the body axis.

3. The hook system according to claim 1, wherein the locking axis of the lock member and the body axis intersect to form an included angle that is an acute angle.

4. The hook system according to claim 3, wherein the acute angle is from about 15° to about 90°.

5. The hook system according to claim 3, wherein the acute angle is about 45°.

6. The hook system according to claim 1, wherein the locking axis of the lock member is approximately parallel to and offset from the body axis.

7. The hook system according to claim 1, wherein the body comprises a lock member housing having a removable exterior cap, the housing supporting the lock member and the removable exterior cap facilitating access to the lock member.

8. The hook system according to claim 1, further comprising a remote control connection operatively coupled to the lock member, the remote control connection comprising a pneumatic line capable of supplying a pressurized gas to disengage the lock member from the hook, thereby allowing the hook to move from the closed position to an open position.

9. The hook system according to claim 8, wherein the pressurized gas is compressed air, compressed nitrogen or other compressed gas.

10. The hook system according to claim 8, wherein the remote control connection is coupled to the body using a fitting.

11. The hook system according to claim 10, wherein the body comprises flanges extending above and to the sides of the fitting, the flanges protecting the fitting during use of the hook system.

12. The hook system according to claim 1, wherein the body and hook are made substantially from a steel.

13. The hook system according to claim 1, wherein the lock member is shaped as a pin.

14. The hook system according to claim 1, wherein the hook comprises a recess shaped to receive the lock member.

15. A load lifting hook system having a remote control, comprising:
an elongated body defining a body axis;
a hook movably coupled to the body; and
a lock member positioned at least partially within the body and selectively engageable with the hook via the remote control to lock the hook in a closed position;
wherein a locking axis of the lock member is distinct from the body axis.

16. A load lifting hook system having a remote control, comprising:
an elongated body;
a hook movably coupled to the body;
a lock member associated with the body and selectively engageable with the hook via the remote control to lock the hook in a desired position; and
a hook clearing member coupled to the body, the hook clearing member disengaging load slings carried by the hook.

17. The hook system according to claim 16, wherein the hook is pivotable between a closed position and an open position, and wherein the hook clearing member straddles the hook, thereby disengaging load slings carried by the hook as the hook pivots from the closed position to the open position.

18. The hook system according to claim 16, wherein the hook clearing member is fixed to the body.

19. The hook system according to claim 16, wherein the hook clearing member comprises two opposing portions positioned to straddle the hook.

20. The hook system according to claim 16, wherein the hook clearing member is formed as one piece with the body.

21. The hook system according to claim 16, wherein the hook clearing member comprises a stop for preventing rotation of the hook beyond a predetermined position.

22. The hook system according to claim 16, further comprising a moveable latch coupled to the body and biased to a first position when the hook is in the closed position, the latch being configured to prevent inadvertent release of a load sling positioned within the hook.

23. The hook system according to claim 22, wherein a width of the latch is greater than a width of the hook.

24. The hook system according to claim 22, wherein the tip of the hook comprises a recess for receiving a portion of the latch.

25. A load lifting hook system having a remote control, comprising:
a body;
a hook coupled to the body and movable between open and closed positions, the hook being lockable in at least the closed position by remote control;
a swivel rotatably coupled to one end of the body; and
a rotation pin extending from the body and engageable with the swivel to limit rotation of the swivel relative to the body to a desired angular range.

26. The hook system according to claim 25, wherein the angular range is less than about 360°.

27. The hook system according to claim 25, wherein the angular range is about 180°.

28. The hook system according to claim 25, wherein the angular range is about 90°.

29. The hook system according to claim 25, wherein the pin is engaged with the swivel to restrict rotation relative to the body.

30. The hook system according to claim 25, wherein the pin is selectively disengageable from the swivel to allow free rotation of the swivel.

31. A load lifting hook system having a remote control, comprising:
a body with a hook pivotably attached at one end;
a lock member engageable with the hook when the hook is pivoted to a locked position; and
a deliberate engagement feature coupled to the body, the deliberate engagement being configured to provide a predetermined resistance to movement of the hook toward the locked position when the hook in unlocked to prevent inadvertent relocking of the lock.

32. The hook system according to claim 31, wherein the deliberate engagement feature comprises a spring such as flat leaf spring or a coil spring.

33. A load lifting hook system having a remote control, comprising:
a body with a hook pivotably attached at one end of the body;
a lock member engageable with the hook when the hook is pivoted to a locked position; and
a retractor coupled to the body and to the hook to urge the hook toward an open position when the hook is not locked.

34. The hook system according to claim 33, wherein the retractor comprises a spring.

35. The hook system according to claim 34, wherein the spring comprises two generally symmetrical side portions and a connecting middle portion between the side portions, the side portions having ends coupled to the body.

36. The hook system according to claim 34, wherein the spring comprises a coil spring having a first stationary end coupled to the body and a second moving end coupled to the hook.

37. The hook system according to claim 36, wherein the body comprises a hook clearing member for disengaging load slings carried by the hook, and wherein the first stationary end of the spring is coupled to the hook clearing member.

38. A load lifting hook system having a remote control, comprising:
an elongate body;
a swivel rotatably coupled to one end of the body and adapted to receive a rotation pin extending from the body and selectively engageable with the swivel, the rotation pin limiting rotation of the swivel relative to the body to a selected angular range;
a hook pivotably coupled to an opposite end of the body, the hook being pivotable between open and closed positions;
a lock pin extending at least partially through the body and engageable with the hook when the hook is pivoted to a closed position to lock the hook in place;
a hook clearing member coupled to the body, the hook clearing member being operatively positioned relative to the hook to disengage a load sling carried by the hook as the hook is pivoted from the closed positioned to the open position;
a latch rotatably coupled to the body and biased to contact a tip of the hook when the hook is in the closed position, the latch being urgable away from the tip of the hook to allow a load sling to be placed on the hook.
a deliberate engagement feature coupled to the body and configured to provide a predetermined resistance to movement of the hook, when the hook is unlocked, toward the locked position; and
a retractor coupled to the body and the hook, wherein, when the hook is unlocked, the retractor urges the hook toward an open position.

39. A method of configuring a load lifting hook system with a remote control to lift a load, comprising:
providing a hook system having a body, a hook coupled to the body, a lock pin positioned at least partially within the body and engageable with the hook when the hook is in a locked position and a deliberate engagement feature coupled to the body that biases the hook when unlocked away from the locked position;
locking the hook by applying a predetermined positive force to the hook greater than a biasing force of the deliberate engagement feature to pivot the hook to the closed position;
allowing the lock pin to engage the hook; and
placing a sling of the load onto a throat of the hook;

40. The method of claim 39, further comprising lowering the load upon reaching a desired location and unlocking the hook by disengaging the lock pin with the hook using a remote control.

41. The method according to claim 39, wherein a locking axis of the lock member is not coaxial with a body axis of the body.

42. The method of claim 39, further comprising using inspection openings formed in the hook to visually confirm that the lock pin has engaged the hook

43. A load lifting hook system having a remote control, comprising:
an elongated body;
a hook pivotably attached to one end of the body; and
a lock member operatively coupled to the body and selectively engageable with the hook via the remote control to lock the hook in a closed position, the lock member having at least one end positioned outside the body to facilitate servicing of the lock member without detaching the hook from the body.
